(19) United States
(12) Patent Application Publication
(10) Pub. No.: US 2023/0284621 A1
(43) Pub. Date: Sep. 14, 2023

(54) HERBICIDAL COMPOSITIONS

(71) Applicant: PBI-Gordon Corporation, Shawnee, KS (US)

(72) Inventors: Dale Sanson, Kearney, MO (US); Jed G. Archuleta, Shawnee, KS (US); Jeffrey W. Marvin, Overland Park, KS (US)

(21) Appl. No.: 18/181,706

(22) Filed: Mar. 10, 2023

Related U.S. Application Data
(60) Provisional application No. 63/318,909, filed on Mar. 11, 2022.

(51) Int. Cl. A01N 43/653; A01N 37/40

(52) U.S. Cl. CPC A01N 43/653; A01N 37/40

(57) ABSTRACT

Stable, aqueous herbicidal compositions are provided, which comprise a phenoxy acid, a benzoic acid compound, a quinoline carboxylic acid, a triazolinone herbicide, a HPPD inhibitor, and a nonionic surfactant dissolved in water. In preferred embodiments, the herbicidal compositions also utilize a basic pH adjuster to provide compositions comprising a solubilized protox inhibitor or a solubilized HPPD inhibitor. The compositions may be provided as a concentrate or ready-to-use herbicidal compositions. Advantageously, compositions of the present invention are both physically and chemically stable when stored for prolonged periods in both ambient and extreme temperature. Additionally, the inventive compositions can provide improved broad control of undesired vegetation by controlling both adult plants and seedlings.

### RELATED APPLICATION

This application claims the benefit of U.S. Provisional Patent Application No. 63/318,909, filed Mar. 11, 2022, which is incorporated by reference herein in its entirety.

### BACKGROUND OF THE INVENTION

### Field of the Invention

The present invention relates to a selective, post-emergent herbicidal compositions for the control of undesired vegetation, such as grassy weeds (e.g., yellow nutsedge, crabgrass, kyllinga, and foxtail) and broadleaf weeds (e.g., chickweed, clover, and dandelion), when applied to the locus of the vegetation. The herbicidal compositions are particularly suited for use in the consumer turf and ornamental markets.

### Description of Related Art

Auxinic herbicidal agents, such as phenoxy acids, benzoic acids, and quinoline carboxylic acids, have been used for many years, individually or in combination, as herbicides for treating turf to control undesirable broadleaf vegetation and grassy weeds without significantly adversely affecting desirable grasses. Similarly, protoporphyrinogen oxidase (protox) inhibitors, such as triazolinone herbicides, have been used to control undesirable broadleaf vegetation. For example, U.S. Pat. No. 10,897,901 to Walter et al. teaches the combination of sulfentrazone and quinclorac for control of post-emergence selective weed control in turf sites. U.S. Pat. No. 6,849,579 to Armbruster et al. teaches a selective postemergent herbicide composition for the control of undesired broadleaf vegetation and grassy weeds comprising the combination of quinclorac and a selective protox inhibitor. However, certain species of undesirable broadleaf vegetation and grassy weeds are becoming more and more resistant to a number of the most widely used herbicides, and thus, there continues to be a need for increasing the herbicidal effectiveness of compositions containing these active ingredients.

Yet, there are several challenges associated with preparing herbicidal compositions comprising multiple active ingredients. For example, many active ingredients are incompatible with each other, which in turn may lead to application problems. Even if compatible, the actives may not remain chemically or physically stable for long periods of time or at extreme temperatures. Furthermore, some actives, such as protox inhibitors and 4-Hydroxyphenylpyruvate dioxygenase (HPPD) inhibitors, are only prepared as suspension concentrates. Because these active ingredients are not solubilized, they may precipitate out of the herbicidal composition.

Accordingly, there is a great need for improved broadleaf and grassy weed control compositions and a method of controlling such noxious vegetation without adversely affecting desirable plants and which reduces the amount of chemical herbicidal agent necessary to obtain broad weed control and efficacy. There is also a need for herbicidal compositions comprising active ingredients that are each solubilized or dissolved within the aqueous medium of the composition.

### SUMMARY OF THE INVENTION

The present invention is broadly concerned with an herbicidal composition comprising, consisting essentially of, or consisting of at least one of an auxinic herbicidal agent, a protoporphyrinogen oxidase (protox) inhibitor, and agriculturally acceptable salts thereof; a 4-hydroxyphenylpyruvate dioxygenase (HPPD) inhibitor, or agriculturally acceptable salts thereof; and a nonionic surfactant.

According to another embodiment of the present invention, there is provided an aqueous herbicidal composition comprising, consisting of, or consisting essentially of a phenoxy acid or salt thereof, a benzoic acid compound or salt thereof, a quinoline carboxylic acid or salt thereof, a triazolinone herbicide or salt thereof, an HPPD inhibitor or salt thereof, and a nonionic surfactant, wherein the phenoxy acid, the benzoic acid compound, the quinoline carboxylic acid, the triazolinone herbicide, the HPPD inhibitor, or salts thereof, and the nonionic surfactant are each dissolved within an aqueous medium of the herbicidal composition.

According to another embodiment of the present invention there is provided an aqueous ready-to-use herbicidal composition according to any formulation described herein, wherein the composition is formulated for application to vegetation without being further diluted.

According to still a further embodiment of the present invention there is provided a method of controlling undesired vegetation comprising applying to the locus of the undesired vegetation an herbicidally effective amount of any aqueous herbicidal composition described herein, including ready-to use herbicidal compositions.

### DETAILED DESCRIPTION

The present invention is concerned with selective, post-emergent herbicidal compositions for the control of undesired vegetation when applied to the locus of the vegetation.

### Herbicidal Compositions

In one or more embodiments, the herbicidal compositions comprise at least one of an auxinic herbicidal agent and a protoporphyrinogen oxidase (protox) inhibitor, a 4-Hydroxyphenylpyruvate dioxygenase (HPPD) inhibitor, and a nonionic surfactant.

In certain embodiments, the herbicidal compositions are stable concentrate compositions, which may be diluted with water shortly before use. In certain other embodiments, the herbicidal compositions are stable, ready-to-use compositions, which may be used without dilution. In most preferred embodiments, the compositions and methods in accordance with embodiments of the present invention advantageously provide an herbicidally effective amount of a phenoxy acid, a benzoic acid compound, a quinoline carboxylic acid, a triazolinone herbicide, and a HPPD inhibitor in a stable aqueous formulation. As used herein, the term “herbicidally effective amount” refers to the amount of a specific ingredient or mixture of ingredients sufficient to exterminate, impair, prevent, and/or suppress the growth of undesired vegetation.

### 1. Active Ingredients

In some embodiments, the compositions comprise an auxinic herbicidal agent, which is suspended, solubilized, or dissolved, preferably dissolved within the aqueous medium of the herbicidal composition. Auxinic herbicidal agents, also known as plant growth regulators, are readily absorbed through both roots and foliage of the undesired vegetation and interfere with cell formation, which results in abnormal root and shoot growth.

In certain embodiments, the auxinic herbicidal agent may be synthetic auxins, such as Group 4 herbicides (e.g., phenoxy acids, benzoic compounds, quinoline carboxylic acids, pyridine-carboxylates, or pyridyloxy-carboxylates), or auxin transport inhibitors, such as Group 19 herbicides. As used herein, the terms “Group 4 herbicide” or “Group 19 herbicide” means an herbicide classified, respectively, as a Group 4 or 19 herbicide by the Weed Science Society of America and/or recognized, respectively, as a Group 4 or 19 herbicide by the U.S. Environmental Protection Agency. The auxinic herbicidal agent may comprise one or more compounds selected from the group consisting of herbicidally active phenoxy, benzoic, quinoline carboxylic acid, pyridine compounds and amine, esters, adducts, and inorganic salts thereof. The salts are preferably selected from a group comprising, but are not limited to, methylamine, ethylamine, isopropyl amine, monomethanolamine, monoethanolamine, monoisopropanol amine, dimethylamine, diethylamine, diisopropylamine, dimethanolamine, diethanolamine, diisopropanolamine, trimethylamine, triethylamine, triisopropylamine, trimethanolamine, triethanolamine, triisopropanolamine, and ammonium, sodium, potassium, lithium, calcium salts of the above acids are also useful. The auxinic herbicidal agent may include acidic compounds, such as (but are not limited to) 2-(2,4-Dichlorophenoxy)propionic acid (2,4-DP), 2,4-dichlorophenoxybutyric acid (2,4-DB), 2-methyl-4-chlorophenoxyacetic acid (MCPA), methylchlorophenoxypropionic acid (MCPP or mecoprop), 2-methyl-4-chlorophenoxybutyric acid (MCPB), 2,4,5-trichlorophenoxyacetic acid (2,4,5-T), 2,3,6-trichlorobenzoic acid (2,3,6-TBA), 3,6-dichloro-2-methoxybenzoic acid (dicamba), 2-methoxy-3,5,6-trichlorobenzoic acid (tricamba), 3-amino-2,5-dichlorobenzoic acid (chloramben), 2-(naphthalen-1-ylcarbamoyl)benzoic acid (naptalam), 2-(4-chloro-2-oxo-1,3-benzothiazol-3-yl)acetic acid (benazolin), 4-amino-3,5,6-trichloropicolinic acid (picloram), trichloroacetic acid (TCA), 2,2-dichloropropionic acid (dalapon), monosodium methyl arsonate (MSMA), 2,3,6-trichlorophenylacetic acid (chlorfenac), 3,6-endoxohexahydrophthalic acid (endothall), 7-chloro-3-methyl-8-quinolinecarboxylic acid (quinmerac), 3,7-dichloro-8-quinolinecarboxylic acid (quinclorac), ((4-amino-3,5-dichloro-6-fluoro-2-pyridinyl)oxy)acetic acid (fluroxypyr), 3,4,6-trichloro-2-pyridinyloxyacetic acid (triclopyr), 3,6-dichloro-2-pyridinecarboxylic acid (clopyralid), 1-methyl heptyl ester (fluroxypyr-meptyl), 4-amino-3,6-dichloropyridine-2-carboxylic acid (aminopyralid), 4-amino-3-chloro-6-(4-chloro-2-fluoro-3-methoxyphenyl)-5-fluoropyridine-2-carboxylic acid (florpyrauxifen), 4-amino-3-chloro-6-(4-chloro-2-fluoro-3-methoxyphenyl)pyridine-2-carboxylic acid (halauxifen), 2-(2,4-dichlorophenoxy)propanoic acid (dichlorprop), 2-(2,4-dichloro-3-methylphenoxy)-N-phenylpropanamide (clomeprop), 6-amino-5-chloro-2-cyclopropylpyrimidine-4-carboxylic acid (aminocyclopyrachlor), or 2-[(E)-N-[(3,5-difluorophenyl)carbamoylamino]-C-methylcarbonimidoyl]pyridine-3-carboxylic acid (diflufenzopyr). Ester forms of the auxinic herbicidal agents include carbon chain lengths, either linear or branched, in which from C₁ to C₂₀ are present. Other auxinic herbicidal agents that may be used with the present invention are described in U.S. Pat. No. 6,849,579, which is incorporated by reference herein in its entirety. In certain embodiments, particularly concentrated forms of the herbicidal composition, the compositions comprise from about 1% to about 30%, preferably about 2.5% to about 25%, more preferably from about 5% to about 20%, or most preferably from about 7.5% to about 17.5% of the auxinic herbicidal agent(s), wherein the stated percentages are by weight and based upon the total weight of the compositions each taken as 100% by weight.

In preferred embodiments, instead of comprising a single auxinic herbicidal agent, the herbicidal compositions may comprise at least three auxinic herbicidal agents. In these preferred embodiments, the at least three auxinic herbicidal agents may be a phenoxy acid, a benzoic acid compound, a quinoline carboxylic acid, and agriculturally acceptable salts thereof. In most preferred embodiments, the phenoxy acid is selected from the group consisting of is 2,4-D, MCPP, 2,4-DP, and mixtures thereof. In other most preferred embodiments, the benzoic acid compound is dicamba, 2,3,6-TBA, tricamba, chloramben, or naptalam, preferably dicamba, and the quinoline carboxylic acid is quinmerac or quinclorac, preferably quinclorac. In these embodiments, and particularly concentrated forms of the herbicidal compositions, the compositions comprise about 2.5% to about 20%, preferably about 4% to about 18%, more preferably about 6% to about 15%, most preferably about 8% to about 12% of the phenoxy acid, wherein the stated percentages are by weight and based upon the total weight of the compositions each taken as 100% by weight. In these embodiments, the compositions comprise from about 0.1% to about 5%, preferably about 0.5% to about 2.5%, more preferably about 0.75% to about 1.5%, most preferably about 1% of the benzoic acid compound, wherein the stated percentages are by weight and based upon the total weight of the compositions each taken as 100% by weight. In these embodiments, the compositions comprise about 1% to about 12.5%, preferably about 2% to about 10%, more preferably about 4% to about 6%, and most preferably about 5.5% of the quinoline carboxylic acid, wherein the stated percentages are by weight and based upon the total weight of the compositions each taken as 100% by weight.

In some embodiments, the herbicidal compositions comprise a protoporphyrinogen oxidase (protox) inhibitor, which may be solubilized or dissolved within the aqueous medium of the herbicidal composition as described below. The protox inhibitor may be any herbicide capable of controlling the growth of undesired vegetation by blocking protoporphyrinogen oxidase, which is an enzyme in the chloroplast of the plant cell that oxidizes protoporphyrinogen to produce protoporphyrin IX. This product is a precursor molecule for both chlorophyll (needed for photosynthesis) and heme (needed for electron transfer chains).

In certain embodiments, the protox inhibitor may be a Group 14 herbicide. As used herein, the term “Group 14 herbicide” means an herbicide classified as a Group 14 herbicide by the Weed Science Society of America and/or recognized as a Group 14 herbicide by the U.S. Environmental Protection Agency. The protox inhibitor may be, but is not limited to, ethyl 2-chloro-3-[2-chloro-5-[4-(difluoromethyl)-3-methyl-5-oxo-1,2,4-triazol-1-yl]-4-fluorophenyl]propanoicacid (carfentrazone-ethyl), N-[2,4-dichloro-5-[4-(difluoromethyl)-3-methyl-5-oxo-1,2,4-triazol-1-yl]phenyl]methanesulfonamide (sulfentrazone), 2-(2,4-dichloro-5-prop-2-ynoxyphenyl)-5,6,7,8-tetrahydro-[1,2,4]triazolo[4,3-a]pyridin-3-one (azafenidin), ethyl 2-[2-chloro-5-[4-chloro-5-(difluoromethoxy)-1-methylpyrazol-3-yl]-4-fluorophenoxy]acetate (pyraflufen-ethyl), 1-(3-chloro-4,5,6,7-tetrahydropyrazolo[1,5-a]pyridin-2-yl)-5-[methyl(prop-2-ynyl)amino]pyrazole-4-carbonitrile (pyraclonil), pentyl 2-[2-chloro-5-(1,3-dioxo-4,5,6,7-tetrahydroisoindol-2-yl)-4-fluorophenoxy]acetate (flumiclorac-pentyl), 2-(7-fluoro-3-oxo-4-prop-2-ynyl-1,4-benzoxazin-6-yl)-4,5,6,7-tetrahydroisoindole-1,3-dione (flumioxazin), methyl 2-[2-chloro-4-fluoro-5-[(3-oxo-5,6,7,8-tetrahydro-[1,3,4]thiadiazolo[3,4-a]pyridazin-1-ylidene)amino]phenyl]sulfanylacetate (fluthiacet-methyl), 2-chloro-4-fluoro-5-[3-methyl-2,6-dioxo-4-(trifluoromethyl) pyrimidin-1-yl]-N-[methyl(propan-2-yl)sulfamoyl]benzamide (saflufenacil), methyl 3-[2-[2-chloro-4-fluoro-5-[3-methyl-2,6-dioxo-4-(trifluoromethyl)pyrimidin-1-yl]phenyl]sulfanyl propanoylamino]propanoate (tiafenacil), 2-chloro-6-nitro-3-phenoxy aniline (aclonifen), methyl-(2,4-dichlorophenoxy)-2-nitrobenzoate (bifenox), 1,3,5-trichloro-2-(4-nitrophenoxy)benzene (chlonitrophen), (2S)-2-[2-chloro-5-[2-chloro-4-(trifluoromethyl)phenoxy]benzoyl]oxypropanoic acid (ethoxyfen), (2-ethoxy-2-oxoethyl) 5-[2-chloro-4-(trifluoromethyl)phenoxy]-2-nitrobenzoate (fluoroglycofen-ethyl), 5-[2-chloro-4-(trifluoromethyl)phenoxy]-N-methyl sulfonyl-2-nitro benzamide (fomesafen), (1-ethoxy-1-oxopropan-2-yl)-[2-chloro-4-(trifluoromethyl)phenoxy]-2-nitrobenzoate (lactofen), 5-[2-chloro-4-(trifluoromethyl)phenoxy]-2-nitrobenzoic acid (acifluorfen), 2-chloro-1-(3-ethoxy-4-nitrophenoxy)-4-(trifluoromethyl)benzene (oxyfluorfen), ethyl (Z)-2-chloro-3-[2-chloro-5-(1,3-dioxo-4,5,6,7-tetrahydroisoindol-2-yl)phenyl]prop-2-enoate (cinidon-ethyl), 5-tert-butyl-3-(2,4-dichloro-5-prop-2-ynoxyphenyl)-1,3,4-oxadiazol-2-one (oxadiargyl), 5-tert-butyl-3-(2,4-dichloro-5-propan-2-yloxyphenyl)-1,3,4-oxadiazol-2-one (oxadiazon), 3-(4-chloro-5-cyclopentyloxy-2-fluorophenyl)-5-propan-2-ylidene-1,3-oxazolidine-2,4-dione (pentoxazone), 2-(5-but-3-yn-2-yloxy-4-chloro-2-fluorophenyl)-4,5,6,7-tetrahydro isoindole-1,3-dione (flumipropyn), propan-2-yl 2-chloro-5-[3-methyl-2,6-dioxo-4-(trifluoromethyl)pyrimidin-1-yl]benzoate (flupropacil), methyl 2-[5-ethyl-2-[[4-[3-methyl-2,6-dioxo-4-(trifluoromethyl)pyrimidin-1-yl]phenoxy]methyl]phenoxy]propanoate (benzfendizone), 2-[2,6-dichloro-4-(trifluoromethyl)phenyl]-4-nitropyrazol-3-amine (nipyraclofen), propan-2-yl 5-[4-bromo-1-methyl-5-(trifluoromethyl)pyrazol-3-yl]-2-chloro-4-fluorobenzoate (fluazolate), 6-[(6,6-dimethyl-5,7-dihydropyrrolo[2,1-c][1,2,4]thiadiazol-3-ylidene)amino]-7-fluoro-4-prop-2-ynyl-1,4-benzoxazin-3-one (thidiazimin), (2-methyl-1-oxo-1-prop-2-enoxypropan-2-yl) 2-chloro-5-[3-methyl-2,6-dioxo-4-(trifluoromethyl)pyrimidin-1-yl]benzoate (butafenacil), ethyl 2-[3-[2-chloro-4-fluoro-5-[3-methyl-2,6-dioxo-4-(trifluoromethyl)pyrimidin-1-yl]phenoxy]pyridin-2-yl]oxyacetate (epyrifenacil), 1,5-dimethyl-6-sulfanylidene-3-(2,2,7-trifluoro-3-oxo-4-prop-2-ynyl-1,4-benzoxazin-6-yl)-1,3,5-triazinane-2,4-dione (trifludimoxazin), a compound having the structural formula 1

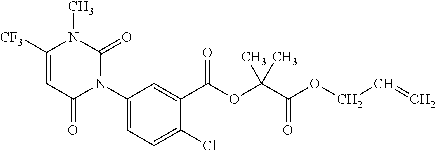 [SMILES: C=CCOC(=O)C(C)(C)OC(=O)c1cc(-n2c(=O)cc(C(F)(F)F)n(C)c2=O)ccc1Cl]

or combinations and/or agriculturally acceptable salts thereof. Other protox inhibitors that may be used with the present invention are described in U.S. Pat. No. 6,849,579, which is incorporated by reference herein in its entirety. In preferred embodiments, the protox inhibitor may be a triazolinone herbicide, such as, sulfentrazone, carfentrazone, azafenidin, and agriculturally acceptable salts thereof. In more preferred embodiments, the protox inhibitor is sulfentrazone. When the protox inhibitor is sulfentrazone, the ingredient is provided in the herbicidal compositions as a liquid suspension concentrate comprising finely milled particles. In certain embodiments, sulfentrazone particles will have a volume-average particle size (D_{V}) of about 2 μm to about 10 μm, preferably about 4 μm to about 8 μm, and more preferably about 5 μm to about 7 μm. The compositions, and particularly concentrated forms of the herbicidal compositions, comprise about 0.05% to about 3%, preferably about 0.1% to about 2%, more preferably about 0.5% to about 1%, most preferably about 0.7% of the protox inhibitor, wherein the stated percentages are by weight and based upon the total weight of the compositions each taken as 100% by weight.

In most embodiments, the compositions comprise an HPPD inhibitor. The HPPD inhibitor may be any herbicide capable of controlling the growth of undesired vegetation by blocking 4-Hydroxyphenylpyruvate dioxygenase, which is an enzyme that breaks down tyrosine. In certain embodiments, the HPPD inhibitor may be a Group 27 herbicide. As used herein, the term “Group 27 herbicide” means an herbicide classified as a Group 27 herbicide by the Weed Science Society of America and/or recognized as a Group 27 herbicide by the U.S. Environmental Protection Agency. The HPPD inhibitor may be a pyrazole, such as, but is not limited to, 4-[3-(4,5-dihydro-1,2-oxazol-3-yl)-2-methyl-4-methylsulfonylbenzoyl]-2-methyl-1H-pyrazol-3-one (topramezone), 2-[4-(2,4-dichloro-3-methylbenzoyl)-2,5-dimethylpyrazol-3-yl]oxy-1-(4-methylphenyl)ethanone (benzofenap), [4-(2,4-dichlorobenzoyl)-2,5-dimethylpyrazol-3-yl]4-methylbenzenesulfonate (pyrazolynate), 1-[2-ethyl-4-[3-(2-methoxyethoxy)-2-methyl-4-methylsulfonylbenzoyl]pyrazol-3-yl]oxyethyl methyl carbonate (tolpyralate), 2,5-dimethyl-4-[2-methylsulfonyl-4-(trifluoromethyl)benzoyl]-1H-pyrazol-3-one (pyrasulfotole), 2-[4-(2,4-dichlorobenzoyl)-2,5-dimethylpyrazol-3-yl]oxy-1-phenylethanone (pyrazoxyfen), or combinations and/or agriculturally acceptable salts thereof. The HPPD inhibitor may also be an isoxazole or an agriculturally acceptable salt thereof, such as, is not limited to, (5-cyclopropyl-1,2-oxazol-4-yl)-[2-methyl sulfonyl-4-(trifluoromethyl)phenyl]methanone (isoxaflutole). The HPPD inhibitor may also be a triketone, such as, but is not limited to, 2-[8-chloro-4-(4-methoxyphenyl)-3-oxoquinoxaline-2-carbonyl]cyclohexane-1,3-dione (fenquinotrione), 3-(2-chloro-4-methylsulfonylbenzoyl)-4-phenylsulfanylbicyclo[3.2.1]oct-3-en-2-one (benzobicyclon), 2-(4-methyl sulfonyl-2-nitrobenzoyl)cyclohexane-1,3-dione (mesotrione), 2-[2-chloro-4-methyl sulfonyl-3-(2,2,2-trifluoroethoxymethyl)benzoyl]cyclohexane-1,3-dione (tembotrione), (1R,5S)-3-[hydroxy-[2-(2-methoxyethoxymethyl)-6-(trifluoromethyl)pyridin-3-yl]methylidene]bicyclo[3.2.1]octane-2,4-dione (bicyclopyrone), 2-(2-chloro-4-methylsulfonylbenzoyl)cyclo hexane-1,3-dione (sulcotrione), 2-[2-chloro-4-methyl sulfonyl-3-(oxolan-2-ylmethoxymethyl) benzoyl]cyclohexane-1,3-dione (tefuryltrione), or combinations and/or agriculturally acceptable salts thereof. In preferred embodiments, the HPPD inhibitor may be a pyrazole selected from the group consisting of topramezone, benzofenap, pyrazolynate, tolpyralate, pyrasulfotole, and pyrazoxyfen. In more preferred embodiments, the HPPD inhibitor is topramezone. When the HPPD inhibitor is topramezone, the ingredient is provided in the compositions as a liquid suspension concentrate comprising finely milled topramazone particles. In certain embodiments, the topramezone particles will have a volume-average particle size (Dᵥ) of about 2 μm to about 10 μm, preferably about 4 μm to about 8 μm, and more preferably about 5 μm to about 7 μm. The compositions, and particularly concentrated forms of the herbicidal composition, comprise from about 0.01% to about 2%, preferably about 0.05% to about 1.5%, more preferably about 0.1% to about 1%, most preferably about 0.2% of the HPPD inhibitor, wherein the stated percentages are by weight and based upon the total weight of the compositions each taken as 100% by weight.

Though the protox inhibitor or the HPPD inhibitor may be suspended, it will be appreciated that, in preferred embodiments, the protox inhibitor or the HPPD inhibitor is advantageously solubilized or dissolved within the aqueous medium of the herbicidal composition. Without being bound by any theory, it was discovered that the solubility of the protox inhibitor and the HPPD inhibitor increases in aqueous environments having a pH of greater than 7. Therefore, a basic pH adjuster may be added to the aqueous medium of the herbicidal composition to increase the pH of the composition to a pH of greater than about 7 to about 9, preferably about 7.5 to about 8.5, and more preferably about 8. If a pH adjuster is used, it will be appreciated that a water-soluble cosolvent (e.g., ethanol, propylene glycol, polyethylene glycols, and the like) may also be used, but is not required, to solubilize and/or dissolve topramezone in the aqueous medium. The pH adjuster may be any compound capable of increasing the pH of the herbicidal composition to a pH about 7 (e.g., sodium hydroxide). In preferred embodiments, the pH adjuster is selected from the group consisting of monoamine, dimethylamine, diethanolamine, diethylamine, triethylamine, digylcolamine, and mineral salts thereof. In more preferred embodiments, the pH adjuster is dimethylamine. The compositions, particularly concentrated forms of the herbicidal composition, comprise from about 1% to about 20%, preferably about 2.5% to about 15%, more preferably about 5% to about 10% of the pH adjuster, wherein the stated percentages are by weight and based upon the total weight of the compositions each taken as 100% by weight.

### 2. Inert Ingredients

The herbicidal compositions may include one or more inert ingredients, depending upon the nature of the product commercialized. In some embodiments, the herbicidal compositions comprise a nonionic surfactant capable of effectively interacting with the active ingredients in the composition. In certain embodiments, the nonionic surfactant may be ethoxylates, ethoxylated alcohols, alkoxylates, cocamides, acrylic copolymers, block copolymers, comb polymers, star-shaped polymers, and mixtures thereof. In other embodiments, the nonionic surfactant may also be a long chain alcohol such as fatty alcohols, cetyl alcohol, stearyl alcohol, cetostearyl alcohol, or oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, polyoxyethylene glycol alkylphenol ethers, nonoxynols, glycerol alkyl esters, glyceryl laurate, polyoxyethylene glycol sorbitan alkyl esters, sorbitan alkyl esters, cocamide MEA, cocamide DEA, dodecyldimethylamine oxide, block copolymers of polyethylene glycol and polypropylene glycol (poloxamers), polyethoxylated tallow amine (POEA), and mixtures thereof. Additional nonionic surfactants may include linear or branched alcohols with ethoxylation ranging from 5 to 35 moles. For example, in certain preferred embodiments, the composition may comprise an additional nonionic surfactant comprising a poly (5, 7, or 9) oxyethylene C₁₁ alcohol. In certain other embodiments, the nonionic ethoxylated alcohol surfactants may be used as the stabilizing surfactant, and no other surfactant is necessary.

In preferred embodiments, the nonionic surfactant may be an ethoxylate, more preferably castor oil with 30 moles of ethoxylation, most preferably castor oil ethoxylate (crystal inhibitor #5 available from Croda Crop Care Harcros Chemical). The compositions, particularly concentrated forms of the herbicidal compositions, comprise from about 0.5% to about 10%, preferably about 1% to about 7.5%, and more preferably about 2% to about 5% of the nonionic surfactant, wherein the stated percentage is by weight and based upon the total weight of the compositions each taken as 100% by weight.

Other inert ingredients are included to improve herbicidal effectiveness, to improve chemical and/or physical stability, or to provide other desirable properties to the compositions. These ingredients may include, but are not limited to, antifoaming agents, antifreeze agents (i.e., a branched or linear glycol, such as propylene glycol, hexylene glycol, glycerin), humectants (e.g., propylene glycol), sequestering agents (e.g., sodium lignosulfonate, Marasperse CBOS-4), or antimicrobial (e.g., Acticide B20).

In preferred embodiments, the herbicidal compositions comprise an auxinic herbicidal agent, a protox inhibitor, a HPPD inhibitor, and a nonionic surfactant. In more preferred embodiments, the herbicidal compositions comprise a phenoxy acid, a benzoic acid compound, a quinoline carboxylic acid, a triazolinone herbicide, a HPPD inhibitor, and a nonionic surfactant, of which are, most preferably, each dissolved within an aqueous medium of the herbicidal composition.

It will be appreciated that the herbicidal composition, when applied at a recommended application rate, exhibits an unexpected herbicidal effect by providing more effective broad control of difficult to eradicate grassy weeds (e.g., crabgrass, goosegrass, dahlisgrass, yellow nutsedge, foxtail) and undesirable broadleaf weeds (e.g., dandelions, clover, chickweed, ground ivy) than the individual herbicidal materials used alone at comparable application rates. Advantageously, the herbicidal compositions provide broad weed efficacy against the growth of undesirable broadleaf vegetation and grassy weeds, all without significant damage to desirable turf and grasses.

It will also be appreciated that the herbicidal compositions, and particularly concentrated forms of the herbicidal compositions, comprise less than about 20% by weight (i.e., 200 grams/liter), preferably less than about 10% by weight, more preferably less than about 5% by weight, most preferably less than 1% by weight of volatile organic compounds, such as acetone, alkylated naphthalenes, xylene, or other low-boiling dispersant organic solvents. In most preferred embodiments, the compositions are substantially free of volatile organic compounds. As used herein, the term “substantially free” is defined as having less than 0.5% by weight, preferably less than 0.1% by weight of a particular ingredient based upon the total weight of the composition.

In certain embodiments, the herbicidal composition may be a concentrate herbicidal composition. As used herein a concentrated herbicidal composition is one that is not intended for direct application to the locus of undesirable vegetation absent some dilution thereof, either as a ready-to-use preparation, or as a preparation that is, for example, mixed with water in a tank immediately prior to application. The following table provides formulation information for a preferred herbicidal composition concentrates in accordance with one embodiment of the present invention.

| | Broad | Intermediate | Narrow |
|---|---|---|---|
| Ingredient | range (wt. %) | range (wt. %) | Range (wt. %) |
| Phenoxy acid (active) | 1-20% | 5-15% | 7.5-12% |
| Quinoline carboxylic acid (active) | 0.5-15% | 1-10% | 2.5-7.5% |
| Benzoic acid compound (active) | 0.05-5% | 0.1-2.5% | 0.5-1.5% |
| Protox inhibitor (active) | 0.01-5% | 0.1-2.5% | 0.25-1% |
| HPPD inhibitor (active) | 0.01-2.5% | 0.05-1% | 0.1-0.5% |
| Sequestering Agent | 0.01-1.5% | 0.05-1% | 0.1-0.75% |
| Antifreeze agent | 1-20% | 2.5-17.5% | 5-15% |
| Surfactant | 0.1-10% | 0.5-7.5% | 1-5% |
| Antimicrobial agent | 0.01-2.5% | 0.05-2.5% | 0.1-1% |
| Antifoam agent | 0.001-1% | 0.005-0.5% | 0.01-0.1% |
| Water | 60-95% | 65-90% | 70-85% |
| Base (pH adjuster) | 0.5-20% | 1-15% | 5-10% |

The concentrate herbicidal compositions are storage stable for at least 3 months at 25° C., preferably at least 6 months at 25° C., more preferably at least 10 months at 25° C., most preferably at least 14 months at 25° C. As used herein, the term “storage stable” means that the active ingredients do not precipitate (physically stable) or chemically degrade (chemically stable) over the specified period. The concentrate herbicidal compositions have a pH between about 7 and about 9, preferably between about 7.5 and about 8.5, and more preferably about 8. The pH of the concentrate herbicidal composition may be adjusted by adding an appropriate amount of the above-described pH adjuster. In other preferred embodiments, the weight ratio of nonionic surfactant to the phenoxy acid is from about 0.1:3 to about 1:10, preferably from about 1:5 to about 1:3. Prior to application, the concentrate herbicidal composition is diluted with water to form an herbicidal use composition comprising 1 part by weight of the concentrate composition diluted in about 2 to about 100 parts by weight of water, preferably about 4 to about 80 parts by weight of water, and most preferably about 8 to about 50 parts by weight of water.

In other embodiments, the herbicidal composition may be in the form of chemically and physically stable ready-to-use compositions. The ready-to-use herbicidal compositions are storage stable for at least 3 months at 25° C., preferably at least 6 months at 25° C., more preferably at least months at 25° C., most preferably at least 14 months at 25° C. The ready-to-use herbicidal compositions have a pH between about 7 and about 9, preferably between about 7.5 and about 8.5, and more preferably about 8. The pH of the concentrate herbicidal composition may be adjusted by adding an appropriate amount of the above-described pH adjuster. Unlike the concentrate compositions, however, the compositions are ready-to-use without dilution. Specifically, these compositions comprise about 1 part by volume of the concentrate in about 10 to about 40 parts by volume of water, although other dilution amounts, such as those recited above are possible. In more preferred embodiments, the ready-to-use herbicidal compositions comprise from about 83.3% to about 97.5% by weight of water, about 0.24% to about 1.65% by weight of a phenoxy acid, about 0.028% to about 0.18% by weight of a benzoic acid compound, about 0.14% to about 0.94% by weight of a quinoline carboxylic acid, about 0.016% to about 0.11% by weight of a triazolinone herbicide, and about 0.004% to about 0.03% by weight of a HPPD inhibitor. In other preferred embodiments, the weight ratio of nonionic surfactant to the phenoxy acid is from about 0.1:3 to about 1:10, preferably from about 1:5 to about 1:3.

Advantageously, the concentrate and ready-to-use herbicidal compositions are capable of being subjected to at least one cycle of exposure, preferably at least three consecutive cycles of exposure, more preferably at least six consecutive cycles of exposure to a temperature of about −15° C. to about −20° C. for a first period of twelve hours followed by exposure to a temperature of about 25° C. to about 50° C. for a second period of twelve hours without formation of precipitates.

### Methods of Forming the Compositions

In some embodiments, the herbicidal compositions are formulated by mixing an auxinic herbicidal agent or a protox inhibitor, an HPPD inhibitor, and a nonionic surfactant in water to form an aqueous mixture. In more preferred embodiments, the herbicidal compositions are formulated by mixing a phenoxy acid, a benzoic acid compound, a quinoline carboxylic acid, a triazolinone herbicide, a HPPD inhibitor, a nonionic surfactant, and a pH adjuster in water to form an aqueous mixture. In these more preferred embodiments, about 0.02 to about 1.38 pounds per gallon, most preferably about 0.880 pounds per gallon of a phenoxy acid, about 0.0023 to about 0.50 pounds per gallon, most preferably about 0.100 pounds per gallon of a benzoic acid compound, about 0.012 to about 0.9 pounds per gallon, most preferably about 0.50 pounds per gallon of a quinoline carboxylic acid, about 0.001 to about 0.20 pounds per gallon, most preferably about 0.060 pounds per gallon of a triazolinone herbicide, and about 0.0004 to about 0.060 pounds per gallon, most preferably about 0.020 pounds per gallon of a HPPD inhibitor are mixed together, although other concentrations may be used within the scope of the present invention. The other ingredients described above may similarly be added to and mixed in the aqueous solution. The ingredients can be mixed in water using, for example, a shear pump or a tank mixer, although other methods of mixing are also within the scope of the invention. The aqueous mixture may be prepared by adding each ingredient to water individually or by forming separate aqueous solutions of the phenoxy acid, the benzoic acid compound, the quinoline carboxylic acid, the triazolinone herbicide, and the HPPD inhibitor and subsequently mixing the separate solutions.

### Methods of Controlling Undesired Vegetation

Methods of controlling undesired vegetation comprise applying an herbicidally effective amount of an aqueous herbicidal composition, such as an herbicidal use composition or ready-to-use composition described above, to the locus of the undesired vegetation. In either form, the herbicidal composition may be applied using known methods for applying liquid herbicides. For example, the herbicidal compositions of the present invention may be sprayed onto a plot of land containing the undesired vegetation using a spray mechanism calibrated to the appropriate application rate. In other certain embodiments, the herbicidal composition is applied to the locus of the undesired vegetation in an amount sufficient to supply from about 0.5 to about 2 pounds per acre, from about 0.75 to about 1.76 pounds per acre, or from about 0.88 to about 1.5 pounds per acre of all active ingredients in the composition. In certain embodiments, the herbicidal composition is applied to the locus of the undesired vegetation in an amount to supply from about 0.1 to about 1.5 pounds per acre of the phenoxy acid, from about 0.01 to about 0.5 pounds of the benzoic acid, from about 0.1 to about 1 pound per acre of the quinoline carboxylic acid, from about 0.009 to about 0.15 pounds per acre of the triazolinone herbicide, and from about 0.005 to about 0.025 pounds per acre of the HPPD inhibitor.

The herbicidal compositions and methods described above are advantageously capable of controlling both seedling and adult (both annual and perennial) grassy weeds and broadleaf weeds, thereby providing improved broad control of undesired vegetation over long periods of time. In certain embodiments, the herbicidal compositions and methods achieve at least about 80% vegetation control, preferably at least about 90% vegetation control, and more preferably at least about 95% vegetation control, after 14 days. As used herein, “% vegetation control” includes the killing of germinated plants, and/or the prevention of seed germination within a defined area of ground during a designated period as determined by visual observation.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the invention. It is to be understood, however, that these examples are provided by way of illustration and nothing therein should be taken as a limitation upon the overall scope of the invention. In the Examples below, the following commercially available products are used:
2,4-D acid (chemical purity 97-99%), Various Suppliers
Quinclorac (chemical purity 97-99%), Various suppliers
Dicamba acid (chemical purity 97-99%) Various suppliers
Sulfentrazone (chemical purity 91-96.4%) Various suppliers
Topramezone (chemical purity 98-99.5%) Various suppliers
Marasperse CBOS-4 by Borregaard Lignotech, biopolymeric dispersant;
Castor Oil Exthoxylate by Various Suppliers, wetting agent;
Propylene Glycol by Various Suppliers, humectant and antifreezing agent;
Harcros® 8810 IND by Harcros Chemicals, industrial grade antifoaming agent;
Dimethylamine (40-45% solution) base and pH adjuster (various suppliers);
Acticide® 20 by THOR Specialties, biocide

### Example I

Exemplary compositions were prepared, with the component amounts provided in the table(s) below. A first composition was prepared for toxicology testing by the EPA having relatively high concentrations of active ingredients.

TABLE 1
Professional Formulation 1: composition
prepared for EPA toxicology testing.

| Ingredient | Purity | Mass (g) | Mass (lb.) | Prep Wt. % |
|---|---|---|---|---|
| 2,4-D Acid | 98.0% | 404.1 | 0.898 | 10.10 |
| Quinclorac | 98.0% | 230.2 | 0.512 | 5.76 |
| Dicamba | 98.76% | 45.8 | 0.101 | 1.14 |
| Sulfentrazone | 96.4% | 28.2 | 0.063 | 0.71 |
| Topramazone | 98.6% | 7.3 | 0.016 | 0.18 |
| Marasperse CBOS-4 | 100.0% | 16.0 | 0.036 | 0.40 |
| Propylene Glycol | 100.0% | 400.0 | 0.889 | 10.00 |
| Crystal Inhibitor #5 | 100.0% | 120.0 | 0.267 | 3.00 |
| Acticide B20 | 100% | 16.0 | 0.036 | 0.40 |
| Harcros 8810 IND | 100.0% | 1.2 | 0.003 | 0.03 |
| DI Water | 100% | 2407.2 | 5.35 | 60.18 |
| Dimethylamine | 44% | 324.0 | 0.72 | 8.10 |
| Totals | | 4000.0 | 8.89 | 100.00% |

| | Active | |
|---|---|---|
| Label | Ingredient % | lbs./gal |
| 2,4-D Acid | 9.90 | 0.88 |
| Quinclorac | 5.64 | 0..50 |
| Dicamba | 1.13 | 0.10 |
| Sulfentrazone | 0.68 | 0.06 |
| Topramazone | 0.18 | 0.016 |

Theoretical Density = 8.89 lbs./gal
pH = {7.0-9.0}

An additional concentrate composition was prepared as provided in the table below, decreasing the concentration of the sulfentrazone by 50% wt.

TABLE 2
Professional Formulation 2: Concentrate Composition.

| Ingredient | Purity | Mass (g) | Mass (lb) | Prep Wt. % |
|---|---|---|---|---|
| 2,4-D Acid | 98.0% | 404.1 | 0.898 | 10.10 |
| Quinclorac | 98.0% | 230.2 | 0.512 | 5.76 |
| Dicamba | 98.76% | 45.8 | 0.101 | 1.14 |
| Sulfentrazone | 96.4% | 14.1 | 0.030 | 0.35 |
| Topramazone | 98.6% | 7.3 | 0.016 | 0.18 |
| Marasperse CBOS-4 | 100.0% | 16.0 | 0.036 | 0.40 |
| Propylene Glycol | 100.0% | 400.0 | 0.889 | 10.00 |
| Crystal Inhibitor #5 | 100.0% | 120.0 | 0.267 | 3.00 |
| Acticide B20 | 100% | 16.0 | 0.036 | 0.40 |
| Harcros 8810 IND | 100.0% | 1.2 | 0.003 | 0.03 |
| DI Water | 100% | 2421.3 | 5.38 | 60.53 |
| Dimethylamine | 44% | 324.0 | 0.72 | 8.10 |
| Totals | | 4000.0 | 8.89 | 99.99% |

| | Active | |
|---|---|---|
| Label | Ingredient % | lbs./gal |
| 2,4-D Acid | 9.90 | 0.88 |
| Quinclorac | 5.64 | 0.50 |
| Dicamba | 1.13 | 0.10 |
| Sulfentrazone | 0.34 | 0.030 |
| Topramazone | 0.18 | 0.016 |

Theoretical Density = 8.89 lbs./gal
pH = {7.0-9.0}

A dilutable concentrate was also prepared for use in the consumer market. The ratio of the active ingredients are the same as previous iterations, but at a more dilute concentration.

TABLE 3
Consumer Formulation 3: Concentrate Composition

| Ingredient | Purity | Mass (g) | Mass (lb.) | Prep Wt. % |
|---|---|---|---|---|
| 2,4-D Acid | 97.9% | 95.7 | 0.211 | 4.78 |
| Quinclorac | 98.0% | 54.4 | 0.120 | 2.72 |
| Dicamba | 98.76% | 10.9 | 0.024 | 0.55 |
| Sulfentrazone | 91.0% | 3.5 | 0.008 | 0.18 |
| Topramazone | 98.9% | 1.7 | 0.004 | 0.09 |
| Marasperse CBOS-4 | 100.0% | 3.8 | 0.008 | 0.19 |
| Propylene Glycol | 100.0% | 94.6 | 0.208 | 4.73 |
| Crystal Inhibitor #5 | 100.0% | 28.4 | 0.063 | 1.42 |
| Acticide B20 | 100% | 7.8 | 0.017 | 0.39 |
| Harcros 8810 IND | 100.0% | 0.30 | 0.0007 | 0.01 |
| DI Water | 100% | 1622.3 | 3.573 | 81.11 |
| Dimethylamine | 44% | 76.6 | 0.169 | 3.83 |
| Totals | | 2000.0 | 4.41 | 100.00% |

| | Active | |
|---|---|---|
| Label | Ingredient % | lbs./gal |
| 2,4-D Acid | 4.68 | 0.40 |
| Quinclorac | 2.67 | 0.23 |
| Dicamba | 0.53 | 0.046 |
| Sulfentrazone | 0.16 | 0.014 |
| Topramazone | 0.085 | 0.0073 |

Theoretical Density = 8.60 lbs./gal
pH = {7.0-9.0}

### Example II

### Chemical Stability Testing

Formulations were prepared as described in Example I. Physically stable formulations (no settling or physical issues observed) were tested for chemical stability over various time spans and temperature conditions. The results are presented in the tables below.

TABLE 4
Professional Formulation 1: 14 Months Ambient Stability

| | Initial Label | 17 Months |
|---|---|---|
| Active Ingredient | Rate | (% Change from Initial) |
| 2,4-D acid¹ | 9.90% | +2.71% |
| Quinclorac¹ | 5.64% | +1.27% |
| Dicamba acid² | 1.13% | +2.04% |
| Sulfentrazone² | 0.68% | +3.60% |
| Topramazone² | 0.18% | −4.79% |

¹Allowable tolerance is +/−5% from initial value.
²Allowable tolerance is +/−10% from initial value.

TABLE 5
Professional Formulation 1: 42 Days Accelerated 40° C. Stability

| | Initial Label | 42 Days @ 40° C. |
|---|---|---|
| Active Ingredient | Rate | (% Change from Initial) |
| 2,4-D acid¹ | 9.90% | +0.66% |
| Quinclorac¹ | 5.64% | −2.78% |
| Dicamba acid² | 1.13% | −4.11% |
| Sulfentrazone² | 0.68% | +1.30% |
| Topramazone² | 0.18% | −3.89% |

¹Allowable tolerance is +/−5% from initial value.
²Allowable tolerance is +/−10% from initial value.

TABLE 6
Professional Formulation 1: Additional Testing

| | Test | |
|---|---|---|
| Physical Testing | Conditions | Comments |
| Three Freeze/ | −15° C. for | Passed, no precipitate observed. |
| Thaw Cycles | twelve hours, | Color/glycol settling observed |
| | then 25° C. for | upon thawing, but returns to |
| | twelve hours, | homogeneity with minor |
| | repeat for three | agitation and/or return to |
| | cycles | ambient conditions |
| Refrigeration | 5° C. for | Passed, no precipitate observed. |
| | approximately | |
| | six months | |

TABLE 7
Professional Formulation 2: 13 Months Ambient Stability

| | Initial Label | 16 Months |
|---|---|---|
| Active Ingredient | Rate | (% Change from Initial) |
| 2,4-D acid¹ | 9.90% | −2.02% |
| Quinclorac¹ | 5.64% | −1.81% |
| Dicamba acid² | 1.13% | −0.80% |
| Sulfentrazone² | 0.34% | +5.71% |
| Topramazone² | 0.18% | −4.40% |

¹Allowable tolerance is +/−5% from initial value.
²Allowable tolerance is +/−10% from initial value.

TABLE 8
Professional Formulation 2: 42 Days Accelerated 40° C. Stability

| | Initial Label | 42 Days @ 40° C. |
|---|---|---|
| Active Ingredient | Rate | (% Change from Initial) |
| 2,4-D acid¹ | 9.90% | +1.38% |
| Quinclorac¹ | 5.64% | −0.23% |
| Dicamba acid² | 1.13% | 0.00% |
| Sulfentrazone² | 0.34% | +0.29% |
| Topramazone² | 0.18% | +1.14% |

¹Allowable tolerance is +/−5% from initial value.
²Allowable tolerance is +/−10% from initial value.

TABLE 9
Professional Formulation 2: Additional Testing

| | Test | |
|---|---|---|
| Physical Testing | Conditions | Comments |
| Three Freeze/ | −15° C. for | Passed, no precipitate observed. |
| Thaw Cycles | twelve hours, | Color/glycol settling observed |
| | then 25° C. for | upon thawing, but returns to |
| | twelve hours, | homogeneity with minor |
| | repeat for three | agitation and/or return to |
| | cycles | ambient conditions. |
| Refrigeration | 5° C. for | Passed, no precipitate observed. |
| | approximately | |
| | six months | |

TABLE 10
Consumer Formulation 3: Ambient Stability

| | Initial Label | |
|---|---|---|
| Active Ingredient | Rate | (% Change from Initial) |
| 2,4-D acid¹ | 4.68% | N/A |
| Quinclorac¹ | 2.67% | N/A |
| Dicamba acid² | 0.53% | N/A |
| Sulfentrazone² | 0.16% | N/A |
| Topramazone² | 0.085% | N/A |

¹Allowable tolerance is +/−5% from initial value.
²Allowable tolerance is +/−10% from initial value.

TABLE 11
Consumer Formulation 3: 30 Days Accelerated 40° C. Stability

| | Initial Label | 30 Days @ 40° C. |
|---|---|---|
| Active Ingredient | Rate | (% Change from Initial) |
| 2,4-D acid¹ | 4.48% | −0.21% |
| Quinclorac¹ | 2.67% | +1.40% |
| Dicamba acid² | 0.53% | 0.00% |
| Sulfentrazone² | 0.16% | 0.00% |
| Topramazone² | 0.085% | −1.53% |

¹Allowable tolerance is +/−5% from initial value.
²Allowable tolerance is +/−10% from initial value.

TABLE 12
Consumer Formulation 3: Additional Testing

| | Test | |
|---|---|---|
| Physical Testing | Conditions | Comments |
| Three Freeze/ | −15° C. for | Passed, no precipitateobserved. |
| Thaw Cycles | twelve hours, | Color/glycol settling observed |
| | then 25° C. for | upon thawing, but returns to |
| | twelve hours, | homogeneity with minor |
| | repeat for six | agitation and/or return to |
| | cycles | ambient conditions. |

As shown in the tables above, formulations prepared in accordance with the present invention were storage stable under ambient conditions for at least one year, or even up to at least one year and five months. Formulations also showed acceptable storage stability under a variety of storage conditions, including periods of hot temperatures (e.g., 40° C.), refrigeration, freeze/thaw cycles, and extreme temperature cycling (e.g., cycling between 40° C. and −25° C.).

### Example III

Ready-to-use compositions were prepared as provided in the tables below. The ready-to-use compositions do not need to be diluted with water prior to application to undesired vegetation. This demonstrates the utility of the solubilized active ingredients to allow for such dilution.

TABLE 13
Nondilutable Formulation 1: Ready-to-Use (RTU)

| Ingredient | Purity | Mass (g) | Mass (lb) | Prep Wt. % |
|---|---|---|---|---|
| Formulation 1 | 100% | 24.45 | 0.204 | 2.45 |
| Concentrate | | | | |
| Acticide B20 | 98.0% | 3.80 | 0.032 | 0.38 |
| Deionized Water | 100% | 971.75 | 2.14 | 97.18 |
| Totals | | 1000.0 | 2.20 | 100.00% |

| | Active | |
|---|---|---|
| Label | Ingredient % | lbs./gal |
| 2,4-D Acid | 0.24% | 0.02 |
| Quinclorac | 0.14% | 0.012 |
| Dicamba | 0.028% | 0.0023 |
| Sulfentrazone | 0.0166% | 0.014 |
| Topramazone | 0.0044% | 0.000.7 |

Theoretical Density = 8.36 lbs./gal
pH = {7.0-9.0}

TABLE 14
Nondilutable Formulation 2: Ready-to-Use (RTU)

| Ingredient | Purity | Mass (g) | Mass (lb.) | Prep Wt. % |
|---|---|---|---|---|
| Formulation 2 | 100% | 24.45 | 0.204 | 2.45 |
| Concentrate | | | | |
| Acticide B20 | 98.0% | 3.80 | 0.032 | 0.38 |
| Deionized Water | 100% | 971.75 | 3.14 | 97.18 |
| Totals | | 1000.0 | 2.20 | 100.00% |

| | Active | |
|---|---|---|
| Label | Ingredient % | lbs./gal |
| 2,4-D Acid | 0.24% | 0.02 |
| Quinclorac | 0.14% | 0.012 |
| Dicamba | 0.028% | 0.0023 |
| Sulfentrazone | 0.0083% | 0.007 |
| Topramazone | 0.0044% | 0.00037 |

Theoretical Density = 8.36 lbs./gal
pH = {7.0-9.0}

### Example IV

### Chemical Stability Testing

Formulations were prepared as described in Example III. Physically stable formulations (no settling or physical issues observed) were tested for chemical stability over various time spans and temperature conditions. The results are presented in the tables below.

TABLE 15
Ready-to-Use Formulation 2: 30 Days Accelerated 40° C. Stability

| | Initial Label | 30 Days @ 40° C. |
|---|---|---|
| Active Ingredient | Rate | (% Change from Initial) |
| 2,4-D acid¹ | 0.24% | +0.83% |
| Quinclorac¹ | 0.14% | −0.71% |
| Dicamba acid¹ | 0.028% | +1.10% |
| Sulfentrazone¹ | 0.0166% | −0.67% |
| Topramazone¹ | 0.0044% | 0.00% |

¹Allowable tolerance is +/−10% from initial value.

TABLE 16
Ready-to-Use Formulation 2: Additional Testing

| | Test | |
|---|---|---|
| Physical Testing | Conditions | Comments |
| Three Freeze/ | −15° C. for | Passed, no precipitateobserved. |
| Thaw Cycles | twelve hours, | |
| | then 25° C. for | |
| | twelve hours, | |
| | repeat for six | |
| | cycles | |

TABLE 17
Ready to Use Formulation 3: 30 Days Accelerated 40° C. Stability

| | Initial Label | 30 Days @ 40° C. |
|---|---|---|
| Active Ingredient | Rate | (% Change from Initial) |
| 2,4-D acid¹ | 0.24% | −.21% |
| Quinclorac¹ | 0.14% | +1.44% |
| Dicamba acid¹ | 0.028% | −1.79% |
| Sulfentrazone¹ | 0.0083% | −0.33% |
| Topramazone¹ | 0.0044% | −0.46% |

¹Allowable tolerance is +/−10% from initial value.

TABLE 18
Ready to Use Formulation 3: Additional Testing

| | Test | |
|---|---|---|
| Physical Testing | Conditions | Comments |
| Three Freeze/ | −15° C. for | Passed, no precipitateobserved. |
| Thaw Cycles | twelve hours, | |
| | then 25° C. for | |
| | twelve hours, | |
| | repeat for six | |
| | cycles | |

### Example V

In this Example, the Formulations 1, 2, and 3 from Example 1 were tested for efficacy and safety in controlling Nimblewill (Muhlenbergia schreberi) in red fescue against an herbicidal formulation in which topramezone made up the lone active component. Formulations 1, 2, and 3 were applied according to two application schemes. The first scheme was a single application A, and the second scheme involved the same single application A followed by a second application B applied 31 days after application A. Formulations 1, 2, and 3 were diluted and applied at an application rate of approximately 1.5 pounds total active per acre. The solo topramezone treatment comprised applying 1.5 fl oz/acre of Pylex brand SC along with 0.5% v/v of methylated seed oil (MSO) as an adjuvant according to the second application scheme (A+B).

The % cover for the Nimblewill and red fescue within the test plots was recorded initially. Then, periodically throughout the trial, the test plots were evaluated for weed control, injury to the red fescue, and bleaching. A rating scale of 0-100 was used for the evaluations. The results are provided below in Table 19.

TABLE 19

| | Initial | Initial | Day 4 | | | Day 7 | | |
|---|---|---|---|---|---|---|---|---|
| | weed | grass | % Weed | % Grass | % | % Weed | % Grass | % |
| Treatment | cover | cover | control | injury | Bleaching | control | injury | Bleaching |
| Control | 27.0 | 41.3 | 0.0 c | 0.0 | 0.0 | 0.0 c | 0.0 c | 0.0 d |
| (no treatment) | | | | | | | | |
| Formulation 1 | 33.0 | 44.5 | 9.3 ab | 0.0 | 0.0 | 52.5 a | 3.8 a | 4.4 bc |
| (A) | | | | | | | | |
| Formulation 1 | 40.5 | 40.8 | 10.0 ab | 0.0 | 0.3 | 47.5 ab | 2.8 b | 4.2 bc |
| (A/B) | | | | | | | | |
| Formulation 2 | 27.8 | 40.5 | 9.0 ab | 0.0 | 0.3 | 50.8 a | 3.0 ab | 4.2 bc |
| (A) | | | | | | | | |
| Formulation 2 | 30.8 | 43.3 | 6.8 b | 0.0 | 0.3 | 49.3 ab | 2.8 b | 3.7 c |
| (A/B) | | | | | | | | |
| Formulation 3 | 50.0 | 32.5 | 8.5 ab | 0.0 | 0.5 | 52.5 a | 2.8 b | 5.1 b |
| (A) | | | | | | | | |
| Formulation 3 | 41.8 | 39.5 | 10.5 a | 0.0 | 0.8 | 52.5 a | 2.5 b | 4.5 bc |
| (A/B) | | | | | | | | |
| Pylex (A/B) | 40.3 | 36.3 | 9.5 ab | 0.0 | 0.3 | 42.8 b | 2.8 b | 13.2 a |

| | Day 14 | | | Day 21 | | |
|---|---|---|---|---|---|---|
| | % Weed | % Grass | % | % Weed | % Grass | % |
| Treatment | control | injury | Bleaching | control | injury | Bleaching |
| Control | 0.0 b | 0.0 c | 0.0 c | 0.0 c | 0.0 b | 0.0 d |
| (no treatment) | | | | | | |
| Formulation 1 | 75.8 a | 3.7 b | 3.4 b | 79.3 b | 0.0 b | 6.6 bc |
| (A) | | | | | | |
| Formulation 1 | 75.3 a | 3.2 b | 3.9 b | 78.5 b | 0.0 b | 7.3 bc |
| (A/B) | | | | | | |
| Formulation 2 | 75.3 a | 3.2 b | 3.4 b | 79.8 ab | 0.0 b | 4.4 c |
| (A) | | | | | | |
| Formulation 2 | 76.8 a | 3.4 b | 3.7 b | 80.8 ab | 0.0 b | 5.7 bc |
| (A/B) | | | | | | |
| Formulation 3 | 76.5 a | 3.2 b | 4.6 b | 80.0 ab | 0.0 b | 7.2 bc |
| (A) | | | | | | |
| Formulation 3 | 77.3 a | 3.2 b | 4.6 b | 80.0 ab | 0.0 b | 8.2 b |
| (A/B) | | | | | | |
| Pylex (A/B) | 80.3 a | 7.9 a | 33.7 a | 83.3 a | 2.3 a | 31.7 a |
| | Day 28 | | | Day 35 | | |
| | % Weed | % Grass | % | % Weed | % Grass | % |
| Treatment | control | injury | Bleaching | control | injury | Bleaching |
| Control | 0.0 c | 0.0 | 0.0 c | 0.0 d | 0.0 | 0.0 c |
| (no treatment) | | | | | | |
| Formulation 1 | 79.0 b | 0.0 | 3.8 b | 83.4 c | 0.0 | 0.5 ab |
| (A) | | | | | | |
| Formulation 1 | 78.3 b | 0.0 | 1.3 bc | 84.5 bc | 0.0 | 0.1 bc |
| (A/B) | | | | | | |
| Formulation 2 | 85.3 a | 0.0 | 1.0 bc | 88.0 ab | 0.0 | 0.1 bc |
| (A) | | | | | | |
| Formulation 2 | 86.0 a | 0.0 | 1.0 bc | 89.3 a | 0.0 | 0.1 bc |
| (A/B) | | | | | | |
| Formulation 3 | 83.5 ab | 0.0 | 1.0 bc | 85.1 bc | 0.0 | 0.0 c |
| (A) | | | | | | |
| Formulation 3 | 82.3 ab | 0.0 | 1.0 bc | 87.5 ab | 0.5 | 0.3 bc |
| (A/B) | | | | | | |
| Pylex (A/B) | 82.5 ab | 1.0 | 12.0 a | 87.1 ab | 0.3 | 1.7 a |
| | Day 42 | | | Day 49 | | |
| | % Weed | % Grass | % | % Weed | % Grass | % |
| Treatment | control | injury | Bleaching | control | injury | Bleaching |
| Control | 0.0 c | 0.0 d | 0.0 b | 0.0 c | 0.0 b | 0.0 b |
| (no treatment) | | | | | | |
| Formulation 1 | 86.0 b | 0.0 d | 0.2 b | 85.6 b | 0.0 b | 0.0 b |
| (A) | | | | | | |
| Formulation 1 | 89.3 b | 6.2 a | 0.1 b | 95.2 a | 5.3 a | 0.0 b |
| (A/B) | | | | | | |
| Formulation 2 | 89.5 b | 0.0 d | 0.0 b | 88.8 b | 0.0 b | 0.0 b |
| (A) | | | | | | |
| Formulation 2 | 93.5 a | 2.8 bc | 0.0 b | 96.3 a | 5.3 a | 0.0 b |
| (A/B) | | | | | | |
| Formulation 3 | 88.5 b | 0.0 d | 0.0 b | 88.0 b | 0.0 b | 0.0 b |
| (A) | | | | | | |
| Formulation 3 | 93.5 a | 2.4 c | 0.0 b | 96.6 a | 538 a | 0.0 b |
| (A/B) | | | | | | |
| Pylex (A/B) | 93.5 a | 5.8 ab | 2.5 a | 95.5 a | 5.8 a | 2.5 a |
| | Day 56 | | | Day 70 | | |
| | % Weed | % Grass | % | % Weed | % Grass | % |
| Treatment | control | injury | Bleaching | control | injury | Bleaching |
| Control | 0.0 d | 0.0 b | 0.0 | 0.0 d | 0.0 | 0.0 |
| (no treatment) | | | | | | |
| Formulation 1 | 85.4 c | 0.0 b | 0.0 | 88.4 c | 0.0 | 0.0 |
| (A) | | | | | | |
| Formulation 1 | 96.6 b | 2.78 a | 0.0 | 97.3 b | 0.5 | 0.0 |
| (A/B) | | | | | | |
| Formulation 2 | 89.6 c | 0.0 b | 0.0 | 90.1 c | 0.0 | 0.0 |
| (A) | | | | | | |
| Formulation 2 | 98.4 ab | 2.5 a | 0.0 | 99.0 ab | 0.8 | 0.0 |
| (A/B) | | | | | | |
| Formulation 3 | 89.2 c | 0.0 b | 0.0 | 88.9 c | 0.0 | 0.0 |
| (A) | | | | | | |
| Formulation 3 | 99.0 a | 3.0 a | 0.0 | 99.7 a | 0.5 | 0.0 |
| (A/B) | | | | | | |
| Pylex (A/B) | 99.3 a | 0.3 b | 0.0 | 99.9 a | 0.0 | 0.0 |

* Values followed by the same letters do not differ statistically.

It can be seen from the above data that less turf injury was observed for Formulations 1, 2, and 3 from day 14 onward as compared to the topramezone only treatment while maintaining comparable weed control.

### Example VI

In this Example, the Formulations 1 and 2 from Example 1 and a Professional Formulation 4, see Table 20 below, were tested for efficacy and safety in controlling a post-emergent blanket crabgrass (Digitaria serotina) against a commercially available composition Q4-Plus available from PBI/Gordon Corporation, Shawnee, Kansas. Q4-Plus is a concentrate comprising 8.43 wt. % quinclorac, 0.69 wt. % sulfentrazone, 11.81 wt. % 2,4-D (dimethylamine salt), and 1.49 wt. % dicamba (dimethylamine salt). Formulations 1, 2, and 4 were diluted and applied at an application rate of approximately 1.5 pounds total active per acre. Q4-Plus was diluted an applied at an application rate of 1.79 pounds total active per acre. Percent blanket crabgrass control was assessed on a 0 to 100% scale relative to the non-treated check with 0% being no control and 100% being complete control. Data were subject to ANOVA (α=0.05) on each rating date and means separated using Fisher's Protected LSD.

TABLE 20
Professional Formulation 4

| Ingredient | Purity | Mass (g) | Mass (lb) | Prep Wt % |
|---|---|---|---|---|
| 2,4-D Acid | 98.0% | 404.1 | 0.890 | 10.10 |
| Quinclorac | 98.0% | 230.2 | 0.507 | 5.76 |
| Dicamba | 98.76% | 45.8 | 0.101 | 1.14 |
| Topramazone | 98.6% | 7.3 | 0.016 | 0.18 |
| Marasperse CBOS-4 | 100.0% | 16.0 | 0.035 | 0.40 |
| Propylene Glycol | 100.0% | 400.0 | 0.881 | 10.00 |
| Crystal Inhibitor #5 | 100.0% | 120.0 | 0.264 | 3.00 |
| Acticide B20 | 100% | 16.0 | 0.035 | 0.40 |
| Hacros 8810 IND | 100.0% | 1.2 | 0.003 | 0.03 |
| DI Water | 100% | 2435.4 | 5.364 | 60.89 |
| Dimethylamine | 44% | 324.0 | 0.714 | 8.10 |
| Totals | | 4000.0 | 8.811 | 100.00% |

TABLE 21
Formulation 4 Characteristics

| | Active | |
|---|---|---|
| Label | Ingredient % | lbs/gal |
| 2,4-D Acid | 9.90 | 0.88 |
| Quinclorac | 5.64 | 0.50 |
| Dicamba | 1.13 | 0.10 |
| Topramazone | 0.18 | 0.016 |

| | |
|---|---|
| Theoretical Density = | 8.88 lbs/gal |
| pH = | {7.0-9.0} |

TABLE 22
Days Post-Application

| | Percent Control | | | | | | | | |
|---|---|---|---|---|---|---|---|---|---|
| Treatment | Day 7 | Day 14 | Day 21 | Day 28 | Day 42 | Day 56 | Day 70 | Day 84 | Day 98 |
| Non-Treated | 0 c | 0 c | 0 d | 0 d | 0 c | 0 c | 0 d | 0 d | 0 d |
| Formulation 1 | 79 a | 100 a | 100 a | 100 a | 100 a | 93.8 a | 83.8 a | 76.3 a | 63.8 a |
| Formulation 2 | 75.2 a | 100 a | 100 a | 100 a | 100 a | 88.8 a | 75 b | 63.8 b | 45 b |
| Formulation 4 | 76.6 a | 98.8 a | 95 b | 90.3 b | 100 a | 90 a | 81.3 ab | 62.5 b | 40 c |
| Q4-Plus 8 pt/A | 62.6 b | 70 b | 55 c | 40 c | 78.8 b | 67.5 b | 47.5 c | 32.5 c | 0 d |
| LSD_{0.05} | 8.6 | 5 | 2.8 | 0.5 | 3.3 | 5.3 | 8.1 | 8.6 | 4.3 |

* Values followed by the same letters do not differ statistically.

On all rating dates, experimental formulations controlled blanket crabgrass statistically greater than Q4-Plus. At 42 days after treatment, all experimental formulations reached 100% control, whereas Q4-Plus was only 78.8% control. Blanket crabgrass began to recover from herbicide applications at Day 56; however, Formulation 1 maintained greater than 60% control throughout the duration of the experiment and was significantly greater than Formulations 2 and 4 at Day 98. All three experimental formulations performed better at Day 98 than Q4-Plus. The results from this experiment indicate experimental formulations with topramezone yielded greater blanket crabgrass control compared to Q4-Plus.

We claim:

1. An aqueous herbicidal composition comprising:
(a) at least one of an auxinic herbicidal agent, a protoporphyrinogen oxidase (protox) inhibitor, and agriculturally acceptable salts thereof;
(b) a 4-Hydroxyphenylpyruvate dioxygenase (HPPD) inhibitor, or agriculturally acceptable salts thereof; and
(c) a nonionic surfactant.

2. The composition of claim 1, wherein the HPPD inhibitor is dissolved within an aqueous medium of the herbicidal composition.

3. The composition of claim 2, wherein the herbicidal composition does not comprise a cosolvent for the HPPD inhibitor.

4. The composition of claim 2, wherein the at least one of the auxinic herbicidal agent and the protox inhibitor is dissolved within the aqueous medium of the herbicidal composition.

5. The composition of claim 2, the composition further comprising a pH adjuster selected from the group consisting of monoamine, dimethylamine, diethanolamine, diethylamine, triethylamine, digylcolamine, and mineral salts thereof.

6. The composition of claim 5, wherein the composition has a pH of greater than about 7.

7. The composition of claim 1, the composition comprising at least the auxinic herbicidal agent and the protox inhibitor.

8. The composition of claim 1, the composition further comprising at least three auxinic herbicidal agents, wherein a first auxinic herbicidal agent comprises a phenoxy acid or agriculturally acceptable salt thereof, a second auxinic herbicidal agent comprises a benzoic acid compound or agriculturally acceptable salt thereof, and a third auxinic herbicidal agent comprises a quinoline carboxylic acid or agriculturally acceptable salt thereof.

9. The composition of claim 8, wherein the phenoxy acid is 2,4-dichlorophenoxyacetic acid (2,4-D), methylchlorophenoxypropionic acid (MCPP), 2-(2,4-Dichlorophenoxy)propionic acid (2,4-DP), or mixtures or agriculturally acceptable salts thereof.

10. The composition of claim 8, wherein the benzoic acid compound is 3,6-dichloro-2-methoxybenzoic acid (dicamba) or an agriculturally acceptable salt thereof.

11. The composition of claim 8, wherein the quinoline carboxylic acid is 3,7-dichloro-8-quinolinecarboxylic acid (quinclorac) or an agriculturally acceptable salt thereof.

12. The composition of claim 1, wherein the protox inhibitor is a triazolinone herbicide or agriculturally acceptable salt thereof.

13. The composition of claim 12, wherein the triazolinone herbicide is N-[2,4-dichloro-5-[4-(difluoromethyl)-3-methyl-5-oxo-1,2,4-triazol-1-yl]phenyl]methanesulfonamide (sulfentrazone) or agriculturally acceptable salt thereof.

14. The composition of claim 1, wherein the HPPD inhibitor is 4-[3-(4,5-dihydro-1,2-oxazol-3-yl)-2-methyl-4-methylsulfonylbenzoyl]-2-methyl-1H-pyrazol-3-one (topramezone) or agriculturally acceptable salt thereof.

15. The composition of claim 1, wherein the composition is storage stable for at least 3 months at 25° C.

16. The composition of claim 1, wherein the composition is capable of being subjected to at least one cycle of exposure to a temperature of about −15° C. for a first period of twelve hours followed by exposure to a temperature of about 25° C. for a second period of twelve hours without formation of precipitates.

17. The composition of claim 16, wherein the composition is capable of being subjected to six of said cycles consecutively without formation of precipitates.

18. The composition of claim 1, wherein the composition further comprises about 20% by weight or less of volatile organic compounds.

19. The composition of claim 1, wherein the composition is formulated for application to vegetation without being further diluted.

20. An herbicidal use solution comprising about 1 part by weight of the composition according to claim 1 diluted in about 2 to about 100 parts by weight of water.

21. The composition of claim 1, wherein the composition is a ready-to-use herbicidal composition comprising:
about 83.3% to about 97.5% by weight of water,
about 0.24% to about 1.65% by weight of a phenoxy acid,
about 0.028% to about 0.18% by weight of a benzoic acid compound,
about 0.14% to about 0.94% by weight of a quinoline carboxylic acid,
about 0.016% to about 0.11% by weight of a triazolinone herbicide, and
about 0.004% to about 0.03% by weight of the HPPD inhibitor.

22. A method of controlling undesired vegetation comprising applying to the locus of the undesired vegetation an herbicidally effective amount of an aqueous herbicidal composition according to claim 1.

23. The method of claim 22, wherein the composition is initially provided as a concentrate, the method further comprising forming a mixture comprising about 1 part by volume of the concentrate in about 2 to about 100 parts by volume of water.

24. The method of claim 22, wherein the composition is applied to the locus of the undesired vegetation at an amount sufficient to supply from about 0.1 to about 1.5 pounds per acre of the phenoxy acid, from about 0.01 to about 0.5 pounds per acre of the benzoic acid compound, from about 0.1 to about 1 pounds per acre of the quinoline carboxylic acid, from about 0.009 to about 0.15 pounds per acre of the triazolinone herbicide, and from about 0.005 to about 0.025 pounds per acre of the HPPD inhibitor.

25. A method of controlling undesired vegetation comprising applying to the locus of the undesired vegetation an herbicidally effective amount of an aqueous ready-to-use herbicidal composition according to claim 21.

26. The method of claim 25, wherein the composition is applied to the locus of the undesired vegetation at an amount sufficient to supply from about 0.1 to about 1.5 pounds per acre of the phenoxy acid, from about 0.01 to about 0.5 pounds per acre of the benzoic acid compound, from about 0.1 to about 1 pounds per acre of the quinoline carboxylic acid, from about 0.009 to about 0.15 pounds per acre of the triazolinone herbicide, and from about 0.005 to about 0.025 pounds per acre of the HPPD inhibitor.

27. An aqueous herbicidal composition comprising a phenoxy acid, a benzoic acid compound, a quinoline carboxylic acid, a triazolinone herbicide, a HPPD inhibitor, and a nonionic surfactant, wherein the phenoxy acid, the benzoic acid compound, the quinoline carboxylic acid, the triazolinone herbicide, the HPPD inhibitor, and the nonionic surfactant are each dissolved within an aqueous medium of the herbicidal composition.

28. The composition of claim 27, the composition comprising:
from about 5% to about 15% of the phenoxy acid;
from about 0.1% to about 2.5% of the benzoic acid compound;
from about 2.5% to about 7.5% of the quinoline carboxylic acid;
from about 0.05% to about 2% of the triazolinone herbicide; and
from about 0.01% to about 1.5% of the HPPD inhibitor,
wherein the weight percentages are based upon the total weight of the composition taken as 100% by weight.
